(19) United States
(12) Patent Application Publication
(10) Pub. No.: US 2012/0025512 A1
(43) Pub. Date: Feb. 2, 2012

(54) CONSTRUCTIONAL LAYOUT FOR PROMOTIONAL INSERT WITH HANDLE FOR LIFTING

(76) Inventor: Alexandre Carlo Magrin Moura, Sao Braz (BR)

(21) Appl. No.: 13/192,872

(22) Filed: Jul. 28, 2011

(30) Foreign Application Priority Data
Jul. 30, 2010 (BR) MU9001137-6

(51) Int. Cl. B42D 1/00

(52) U.S. Cl. 281/15.1

(57) ABSTRACT

A constructional layout for promotional insert with handle for lifting includes a distribution in an organized and practical manner, allowing the lifting of the insert and, consequently, protection of the booklet. Another advantage is that the lifting of the insert in internal rear-view mirrors of vehicles, knobs, handles and similar ones allows the immediate access and the fast reading of the print media, making the promotional means extremely effective.

### BACKGROUND OF THE INVENTION

The present application claims the benefit of priority to Brazilian Utility Model Application n° 9001137-6 filed on Jul. 30, 2010 which is to be incorporated herewith in its entirety.

The present invention relates to a constructional layout for a promotional insert with handle for lifting, notably developed to allow the lifting of the insert, enlarging the traffic and distribution area through the placement in vehicle rear-view mirrors, door handles of rooms from hotels, lodging houses, residences, bar gates, among others, allowing the immediate access and the fast reading of the print advertisements.

As it is largely known, there are many types of promotional communication nowadays, specially developed to reach different audiences through both the digital and print media, in that the print media provides an immediate access, allowing a fast reading and subsequent new reading, and may contain any type of information such as food and restaurant advertisings, advertising of goods and services, lodging promotions, travel packages, religious issues, events, courses, among others.

Another advantage of the print media consists of the fact that it is a popular means, adaptable to the rhythm of the reader, allowing a selective reading, besides presenting a fast traffic advertisement.

The referred print media can occur through newspapers, magazines, posters, flyers, direct mail, inserts, brochures, catalogs, among others, where the advertiser has a series of options to promote its products presenting a relatively low cost.

Nevertheless, in a general manner, both the brochures and the catalogs which present more than a print page are distributed at random, especially in the residential areas, where the delivery people throw the print media in the houses garages or yards, generating wastes for the holders that do not even read the advertisements. Another inconvenience is the dimension of the brochures, flyers, among others, that does not allow the proper insertion into the regular mail boxes, causing their blocking and the crushing of the print media and, consequently, damage to the promotional reading.

A fast research on the patent database brought to light some documents related to promotional brochures, such the document Brazilian Utility Model Application no. PI9604090-4, that is about a promotional notebook in the format of a check book, but, instead of serving as a payment order, its internal pages represent individual instruments or flyers, all of them or each one of them, sponsored by a company or that eventually may take part of the event, providing attractive conditions to the consumer, represented by discounts, payment periods or special payment period and conditions, promotional giveaways and/or other types of offers that eventually may awake a greater interest in the final consumer.

Other document found under the Brazilian Utility Model Application no. MU 7700964-9 is about a promotional chart, comprising a page, preferably rectangular, made of paper with a suitable density or grammage, having one printing part in the format of a header with different information, while the remaining part is subdivided into many small rectangles, each one consisting of a removable self-adhesive label, and each label is printed with some kind of confidential information that, for its turn, is totally covered with a scrapping layer or film.

Another document under the Brazilian Utility Model Application no. PI 9604372-5 refers to a promotional folder, consisting of two substantially hard covers, an anterior and a posterior one, preferably in square format and with the same dimensions, perfectly overlapping one over the other, as they are articulately linked by one of their edges, where a fold is made, allowing the opening and/or closing of the aforementioned covers, and in the opposite side of the fold such covers have, next to their edges, internal magnetized sheaths or bands, substantially thin, one in front of the other, linking with a light locking the two covers that also internally include at least one print page with one or more folds, forming one, two or more parts subject to overlapping, and such parts with dimensions and formats always equal or slightly smaller than such covers.

Although the referred print medias promote the ad service in general, the distribution is conventional allowing damage to them and, consequently, preventing their reading.

The present invention provides for a promotional insert comprising of a distribution in an organized and practical manner, allowing the lifting of the insert in internal rear-view mirrors of vehicles, knobs, handles and similar ones allows the immediate access and the fast reading of the print media, and protection of the booklet.

### SUMMARY OF THE INVENTION

A constructional layout for a promotional insert with handle for lifting in accordance with the present invention generally includes a promotional insert consists of a distribution in an organized and practical manner, allowing the lifting of the insert and, consequently, protection of the booklet.

Another advantage in the present invention for the constructional layout for a promotional insert with handle for lifting, enlarges the traffic and distribution area through the placement in vehicle rear-view mirrors, door handles of rooms from hotels, lodging houses, residences, among others.

In accordance with the present invention such promotional insert is comprised of two complementary parts, as follows: a protective cover and an internal booklet, which is constituted of a set of print pages whose dimension was reduced in comparison to the protective cover, in that the print pages present a central fold made in a longitudinal manner for application of fixation clips; while the referred pages are overlapped one over the others and assembled on the internal surface of the protective cover.

Particularly such protective cover is composed of a print page made of coated paper or other type of appropriate paper, whose central part has a longitudinal fold forming two identical pages. Each identical page presents an extension of the upper edge in a semi-circular format, where a hole is made in the center, and at the center of each hole a transversal rip is made; and the transversal rips, for their turn, are arranged in a mirror manner. Thus, when the central crease of the protecting cover is folded, the identical pages are overlapped one over the other aligning the holes and transversal rips, forming the handle for lifting.

### BRIEF DESCRIPTION OF THE DRAWINGS

To complement the current specification in order to obtain a better comprehension of the features of the utility model patent and in accordance to a preferable practical performance of it, the specification is followed of a series of drawings, attached herein, where, as illustrative manner, although not limited, the following is represented:

FIG. 1 illustrates a plan view of the protective cover;

FIG. 2 illustrates a plan view of the internal booklet;

FIG. 3 shows the exploded view of the insert, showing the elements;

FIG. 4 illustrates a perspective view of the insert assembled in closed position;

FIG. 5 illustrates a perspective view of the insert assembled in open position;

FIGS. 6 and 7 represent the perspective views of the insert illustrating the assembly in a internal rear-view mirror of vehicles and handles.

### DETAILED DESCRIPTION

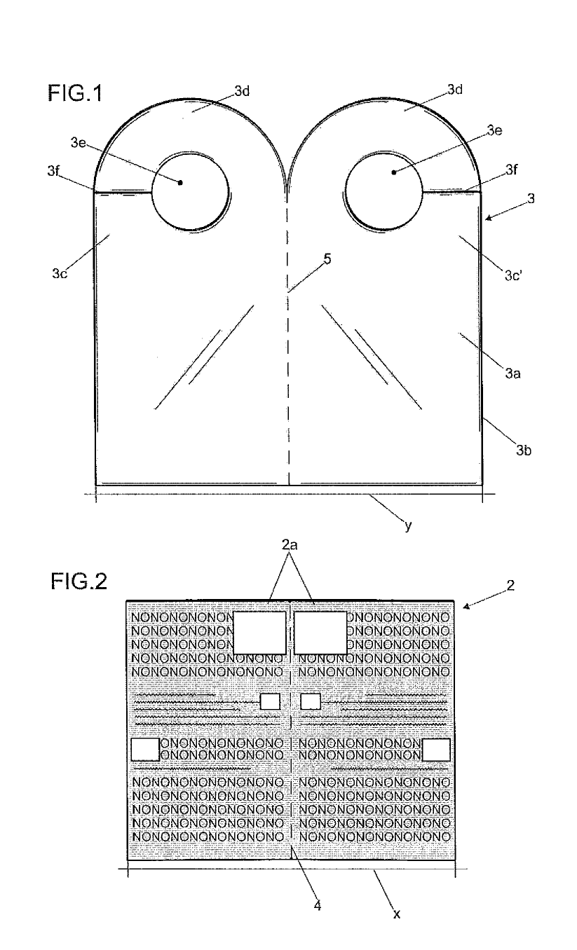

With reference to FIGS. 1, 2, and 3, there is shown in accordance with the present invention generally including a constructional layout for a promotional insert with handle for lifting, more specifically it is about a promotional insert (1) notably developed to enlarge the traffic and distribution area, allowing the lifting of the insert and, consequently, the booklet protection.

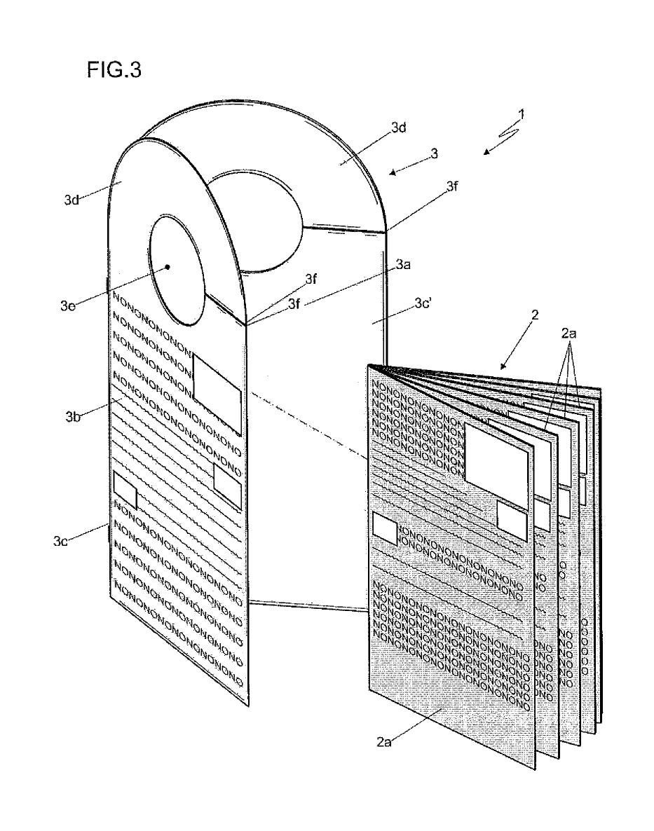

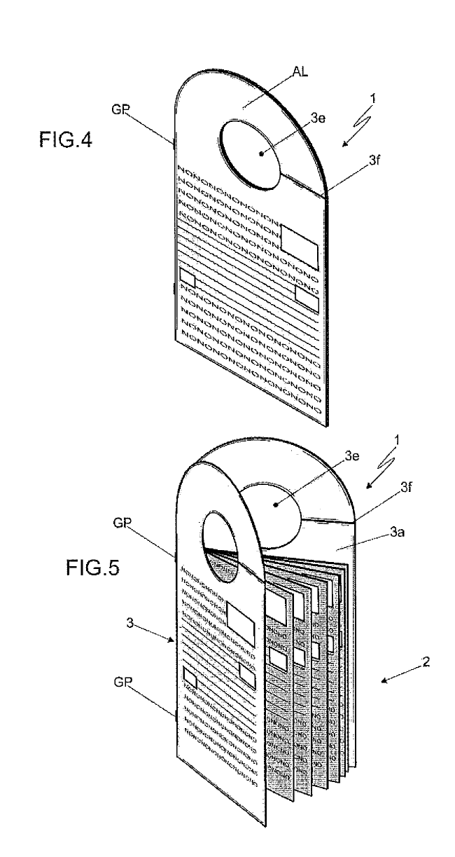

The present invention generally including a promotional insert (1) (see FIG. 3) is composed of two complementary parts, as follows: an internal booklet (2) and one protective cover (3), in that the internal booklet (2) is composed of a set of print pages (2a) preferably made of coated paper whose width (x) as shown in FIG. 2 is reduced in comparison with the protective cover (3) width (y) as shown in FIG. 1, in that such print pages (2a) present a central fold (4), made in a longitudinal manner for application of fixation clips (GP) as seen in FIG. 4, while the referred print pages (2a) are overlapped one over the other and assembled on the internal surface (3a) of the internal portion of the protective cover (3) as depicted in FIGS. 1 and 3.

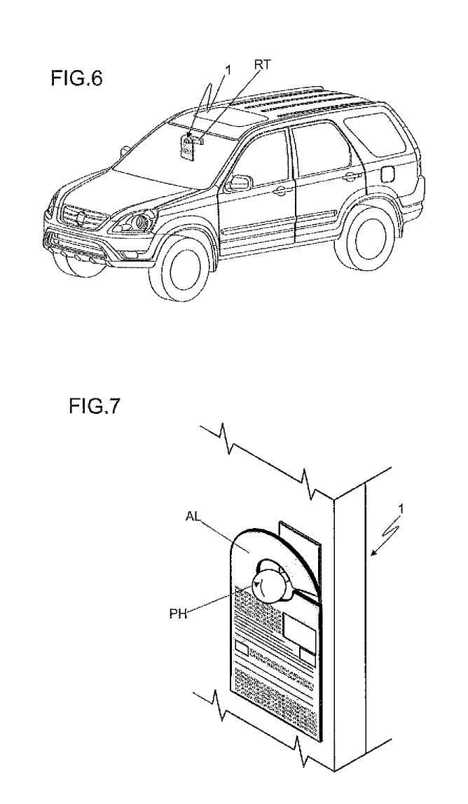

Such protective cover (3), as shown in FIGS. 1 and 3, is composed of a print page (3b) preferably made of coated paper or other appropriate type of paper, whose central part presents longitudinal fold (5) providing two identical pages (3c′) and (3c). Such identical pages (3c) and (3c′) presents an extension (3d) of the upper edge in a semi-circular format, where a hole (3e) is made in the central portion, and from each hole a transversal rip (3f) is made, and such transversal rips, for their turn, are arranged in a mirror manner. Thus, when the central crease (5) of the protecting cover (3) is folded, the identical pages (3c) and (3c′) are overlapped one over the other aligning the holes (3e) and the transversal rips (3f), forming the handle for lifting (AL) as illustrated in FIGS. 4 and 7, allowing the lifting in rear-view mirrors (RT) of vehicles in general as seen in FIG. 6, lifting in hotel door handles (PH) as shown in FIG. 7, among others.

The promotional insert offers material advantages regarding the documents in technical status, meeting totally the requirements that define the utility model patent, that is, it performs the matching and alteration of already known elements, providing new shape or layout, resulting in operational improvement in its use or manufacturing.

Although there has been hereinabove described a constructional layout for promotional insert with handle for lifting with attached hinge cover assembly in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A constructional layout for promotional insert with handle for lifting comprising:
a promotional insert to enlarge the traffic and distribution area through the placement in vehicle handles, door handles for hotel rooms, lodging houses, residences, among others;
said promotional insert comprising two complementary parts including an internal booklet and a protective cover;
said internal booklet is composed of a set of print pages each with a page width smaller in comparison than a protective cover width,
said print pages having a central longitudinal f old for enabling application of fixation clips and referred print pages overlapped one over one another and assembled on the internal surface of the protective cover;
said protective cover is composed of a print page with a longitudinal fold providing two identical pages;
said identical pages having a semi-circular upper edge with a hole in the central portion and transversal rips from the center of each hole arranged in a mirror manner in order that overlapping of the identical pages align the relevant holes and transversal rips forming the lifting handle.

2. The constructional layout for promotional insert with handle for lifting according to claim 1 wherein said print pages are made of coated paper.

3. The constructional layout for promotional insert with handle for lifting according to claim 1 wherein said protective cover print page is made of coated paper.
